(19) United States
(12) Patent Application Publication
(10) Pub. No.: US 2014/0244477 A1
(43) Pub. Date: Aug. 28, 2014

(54) ELECTRONIC CLOSED LOOP FEEDBACK SYSTEM FOR PROCESSING DATA VALUES REPRESENTING PRODUCT FEATURES OF AN ELECTRONIC CREDIT ACCOUNT

(71) Applicant: CreditCast Inc., Toronto (CA)

(72) Inventor: Nanda Kishore KOLATHUR, Toronto (CA)

(73) Assignee: CREDITCAST INC., Toronto (CA)

(21) Appl. No.: 13/778,243

(22) Filed: Feb. 27, 2013

(51) Int. Cl. G06Q 40/00

(52) U.S. Cl. CPC G06Q 40/025
USPC 705/38

(57) ABSTRACT

A system includes a core server for administration of electronic credit accounts, payment devices for payment and receipt of notifications, and a credit product engine including a credit product database for maintaining credit product data records. Each credit product data record includes a dynamic index of attribute values and associated data values representing product features for the electronic credit accounts. The credit product engine is in communication with the core server over a network. The processor is configured to determine current profile values and target values, activate current data values representing current product features associated with the attribute values in the dynamic index corresponding with the current profile values, monitor activity on the electronic credit accounts by the payment devices including receiving credit data records over the network and dynamically adjust the dynamic index to urge utilization of the electronic credit accounts by the payment devices towards the target values.

### FIELD OF TECHNOLOGY

The present disclosure relates to electronic credit accounts. Certain embodiments provide a system and a method for processing data values representing product features of an electronic credit account.

### BACKGROUND

Various prior art systems exist for accessing a borrower's credit profile and determining data values representing product features of an electronic credit account for the borrower. Conventionally, a credit lender such as a bank, credit union, retail store, or other financial institution, requests and evaluates a borrower's credit profile upon the borrower applying for a new or renewed electronic credit account. An electronic credit account can be a revolving credit account such as a credit card, personal or home equity line of credit, and the like, or a non-revolving credit account such as a mortgage, home equity loan, auto loan, personal loan, and the like. Product features include an interest rate to be charged, a credit limit (in case of a revolving electronic credit account), and a maximum loan amount (in case of a non-revolving electronic credit account), for example. Borrowers agree to service the electronic credit accounts by making periodic payments according to the terms and conditions associated with the electronic credit accounts.

A well-known product feature is the interest rate that is charged on the outstanding balance of the electronic credit account. The interest rate can be determined at a fixed rate over a fixed time period, or at a variable rate tied to a benchmark rate such as the London Interbank Offered Rate (LIBOR) or 30-year US Treasury bond yield. The interest rate, together with any electronic credit account fees, permits revenue to be earned from utilization of the electronic credit account.

Typically, the interest rate is determined according to the credit profile of the borrower. The credit profile can be used to assess the borrower's credit risk. If the credit profile indicates a higher credit risk, then a higher interest rate is determined for the electronic credit account. If the credit profile indicates a lower credit risk, then a dower interest rate is determined for the electronic credit account. A credit reporting agency, also referred to as a credit bureau, such as Equifax, Transunion or Experian, maintains credit profiles for many actual or potential borrowers, based on data from creditors such as financial institutions.

Conventionally, the credit profile maintained by a credit reporting agency is accessed when a new electronic credit account is opened (enrolled), and certain product features are determined based on the credit profile of the borrower at the time of enrollment. However, the credit profile of the borrower can change after the time of enrollment, while the product features remain static and do not change. If, for example, several electronic credit accounts are enrolled and the product features for each account are fixed at the time of opening, then the product features for each account may not reflect the changes to the underlying credit risk if these accounts become fully utilized. Furthermore, if the lender and the borrower are not informed of the credit risk changes, then the electronic credit accounts may not be utilized efficiently.

According to known solutions, after an electronic credit account is enrolled, the associated credit profile can be accessed periodically by the creditor, together with internal records relating to payments, and the product features of the electronic credit account can be changed. For example, if the electronic credit account and the associated credit profile are kept in good standing, then the credit limit can be increased, or the interest rate can be decreased. Alternatively, if the electronic credit account or the associated credit profile is not kept in good standing, then the credit limit can be decreased, or the interest rate can be increased. According to prior solutions, the product features can be updated sporadically with no or poor transparency as to the reasons why product features have changed. Furthermore, current solutions are not sensitive to credit risk changes over time on a substantially real-time basis, as product features can only be adjusted after some delay or lag time Legal requirements such as the Credit Card Act of 2009 in the US, containing a notice requirement, contribute to the lag time and provide a motivation to communicate some product feature changes to borrowers at the earliest opportunity.

Improvements in systems and methods for processing data values representing product features of an electronic credit account are desirable.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF THE DRAWINGS

Examples are illustrated with reference to the attached figures. It is intended that the examples and figures disclosed herein are to be considered illustrative rather than restrictive.

FIG. 1 is a block diagram of a system for processing data values representing product features of an electronic credit account in accordance with an example;

FIG. 2 is a block diagram of a system for processing data values representing product features of an electronic credit account in accordance with a another example;

FIG. 3 is a flowchart illustrating an example of a method of determining a dynamic index including data values representing product features of an electronic credit account, monitoring payment device activity, and adjusting the dynamic index;

FIG. 4 is a flowchart illustrating an example of a method of monitoring payment device activity and adjusting the dynamic index of FIG. 3; and

FIG. 5 is a block diagram of a system for processing data values representing product features of an electronic credit account in accordance with yet another example.

### DETAILED DESCRIPTION

The following describes a system that includes a core server for administration of one or more electronic credit accounts, a plurality of payment devices for payment and receipt of notifications in relation to the one or more electronic credit accounts, a credit product engine including at least one processor, a memory coupled to the credit product engine for storing data, an application program stored in the memory and accessible by the at least one processor for directing processing of the data by the at least one processor, and a credit product database for maintaining a plurality of credit product data records. Each credit product data record includes a dynamic index of attribute values and associated data values representing product features for the one or more electronic credit accounts. The credit product engine is in communication with the core server over a network, and the at least one processor is configured to determine one or more current profile values and one or more target values for each electronic credit account, in response to the determining step, activate one or more current data values representing one or more current product features associated with the one or more attribute values in the dynamic index corresponding with the one or more current profile values, monitor activity on the electronic credit accounts by the payment devices wherein the monitoring includes receiving one or more credit data records over the network, and, in response to the monitoring, dynamically adjust the dynamic index to urge utilization of the electronic credit accounts by the payment devices towards the target values.

Throughout the following description, specific details are set forth in order to provide a more thorough understanding to persons skilled in the art. However, well-known elements may not be shown or described in detail to avoid unnecessarily obscuring the disclosure. Accordingly, the description and drawings are to be regarded in an illustrative, rather than a restrictive, sense.

This disclosure relates generally to electronic credit accounts, and particularly to methods and systems for processing data values representing product features of an electronic credit account.

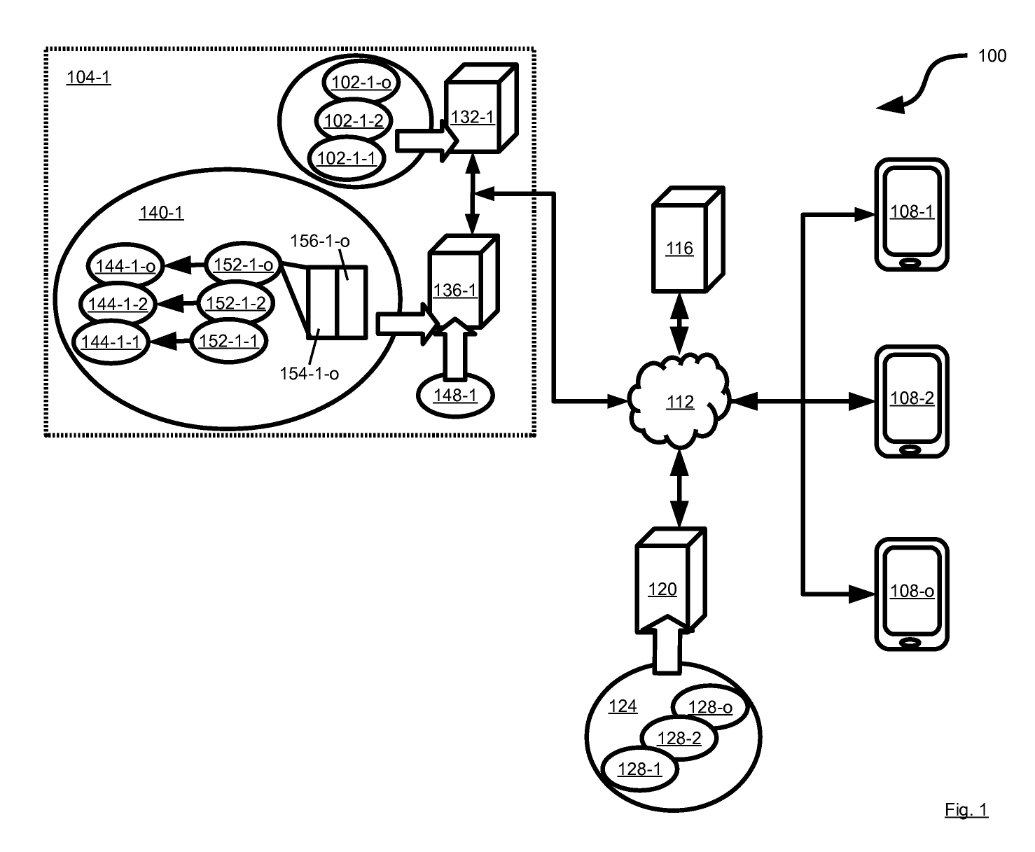

A block diagram of an example of a system 100 for processing data values 156-1 representing product features of an electronic credit account 102-1 is shown in FIG. 1.

The system 100 includes a plurality of integrated payment devices 108-1, 108-2, . . . 108-o (generically referred to herein as “payment device 108” and collectively as “payment devices 108”), all of which are connected to a credit product engine 136-1 and a core server 132-1 (within a financial institution intranet 104-1) via a network 112. The core server 132-1 connects to the credit product engine 136-1 via the financial institution intranet 104-1. In one example, the core server 132-1 and the credit product engine 136-1 are associated with one particular financial institution intranet 104-1.

According to one example, each payment device 108 is associated with an electronic credit account 102 (e.g., administered by a core server 132, discussed below) of a borrower, such as a consumer, a business entity, a government agency or other similar entity seeking credit. The electronic credit accounts 102-1-1, 102-1-2, . . . 102-1-o administered by core sever 132-1 are generically referred to herein as “electronic credit account 102-1” and collectively as “electronic credit accounts 102-1”. In other examples, the electronic credit accounts 102-2-1, 102-2-2, . . . 102-2-o administered by core sever 132-2 are generically referred to herein as “electronic credit account 102-2” and collectively as “electronic credit accounts 102-2”, and so forth. The core servers 132-1, 132-2, . . . 132-n are generally referred to herein as “core server 132” and collectively as “core servers 132”. The electronic credit accounts administered by core servers 132 are generally referred to as “electronic credit account 102” and collectively as “electronic credit accounts 102”. The credit product engines 136-1, 136-2, . . . 132-n are generally referred to herein as “credit product engine 136” and collectively as “credit product engines 136” and so forth.

Typically, the payment device 108 has payment and/or notification capabilities in relation to the electronic credit account 102-1. In other examples, the payment device 108 has point of sale capabilities to enable transactions such as purchases to be made on the electronic credit account 102-1. According to one example, the payment device 108 is an electronic device, such as a desktop computer, notebook computer, tablet computer, cellular phone, smartphone, mobile device, and so forth. According to a further example, the payment device 108 is an automated teller machine (ATM) (not shown). According to other examples, several payment devices 108 can be associated with the same electronic credit account 102-1. Still in other examples, several electronic credit accounts 102-1 can be associated with the same payment device 108. Activity by the payment device 108 using the electronic credit account 102-1 (e.g. payments, transactions, etc.) is administered by the core server 132-1.

Each electronic credit account 102-1 is typically, but not always, associated with one particular financial institution intranet 104-1 (and connected architecture including core server 132-1, credit product engine 136-1, etc.). The term “financial institution” refers to an institution that provides financial services to clients or members of the institution. Generally, but not always, financial institutions are regulated by a government or other regulatory authority. Banks, credit unions, asset management firms, securities dealers, stock brokerages, money lending companies, insurance brokerages, and the like, are examples of financial institutions. Example electronic credit accounts 102-1 may be associated with different types of instruments including credit cards, secured credit cards, pre-paid credit cards, retail store cards, installment loans, personal loans, personal line of credit, auto loans, mortgages, home equity line of credit, home equity loans and other similar products.

The core server 132-1 is typically a server or mainframe within a housing containing an arrangement of one or more processors, volatile memory (i.e., random access memory or RAM), persistent memory (i.e., hard disk devices), and a network interface (to allow the core server 132-1 to communicate over a network 112 and/or the financial institution intranet 104-1) all of which are interconnected by a bus. Many computing environments implementing the core server 132-1 are within the scope of the present specification.

The credit product engine 136-1 is a server or mainframe within a housing containing an arrangement of one or more processors, volatile memory (i.e., random access memory or RAM), persistent memory (i.e., hard disk devices), and a network interface (to communicate over network 112 with payment devices 108 and over a financial institution intranet 104-1 with a core server 132-1) all of which are interconnected by a bus. Many computing environments implementing the credit product engine 136-1 are within the scope of the specification.

The core server 132-1 is typically connected to other computing infrastructure associated with the financial institution intranet 104-1, including analyst screens, printers, data warehouse or file servers, and the like. The core server 132-1 is configured to perform core financial service operations for the financial institution. The core server 132-1 administers the electronic credit accounts 102-1-1, 102-1-2, . . . 102-1-o, each of which is associated with the respective payment device 108-1, 108-2, . . . 108-o, for example.

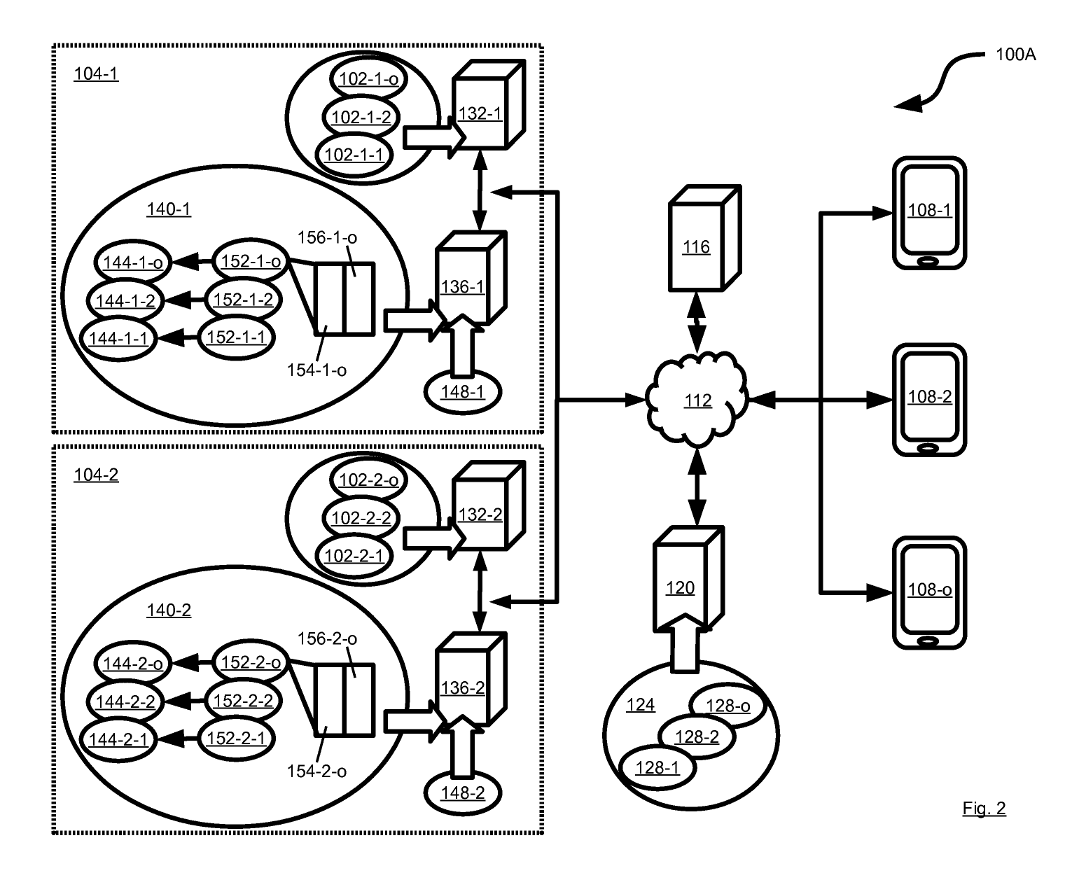

Each of the core server 132-1 and the credit product engine 136-1 are typically maintained as part of a computing environment associated with one particular financial institution (and intranet 104-1). Therefore, the core server 132-1 and the credit product engine 136-1 are typically different from core servers 132-2, . . . 132-n and the credit product engines 136-1, . . . 136-n, respectively, that are associated with different financial institutions (as discussed below with reference to FIG. 2 and the term “financial institution architecture”). Different configurations of processors, memory, operating systems and applications loaded on the memory, may be implemented on each core server 132 and each credit product engine 136.

The credit product engine 136-1 is connected to a credit product database 140-1 that maintains the attribute values 154-1 and the data values 156-1 associated with the electronic credit accounts 102-1. The data values 156-1 and the attribute values 154-1 can be associated in a dynamic index 152-1 (as discussed below). In one non-limiting example, the dynamic index 152-1 (including the data values 156-1 and the attribute values 154-1) are stored in the credit product database 140-1 or a component thereof in a structured format, such as the XML format.

The credit product database 140-1 can be a database application loaded on the credit product engine 136-1, a stand-alone database server, a virtual machine, or any other suitable database. According to one example, the credit product database 140-1 maintains credit product data records 144-1-1, 144-1-2, . . . 144-1-o for each payment device 108-1, 108-2, . . . 108-o (and associated electronic credit account 102-1-1, 102-1-2, . . . 102-1-o). The credit product data records associated with financial institution intranet 104-1 are generically referred to herein as “credit product record 144-1” and collectively as “credit product records 144-1”. Credit product data record 144-1-1 corresponds with financial institution intranet 104-1 and payment device 108-1 (and electronic credit account 102-1-1). Credit product data record 144-1-2 corresponds with financial institution intranet 104-1 and payment device 108-2 (and electronic credit account 102-1-2), and so on.

The product features for the electronic credit accounts 102-1 are represented as data values 156-1. The term “product features” is intended to encompass any feature associated with an electronic credit account 102-1 including interest rate, credit limit, payment period, annual fee, late fee, points, rewards, etc. According to certain examples, a locked or unlocked status can be considered a product feature.

Each credit product data record 144-1 includes one or more data values 156-1. The data values 156-1 can be associated with one or more attribute values 154-1 in a dynamic index 152-1. The dynamic index 152-1-1 can be stored in the credit product data record 144-1-1, the dynamic index 152-1-2 can be stored in the credit product data record 144-1-2, and so forth. In one example, the attribute value 154-1 represents a value associated with the payment device 108 such as total credit limit or total balance. In other examples, the attribute value 154-1 represents a value associated with at least one electronic credit account 102 associated with the payment device 108, or at least one electronic credit account 102 associated with the borrower.

Furthermore, each credit product data record 144-1 can include one or more current profile values 162-1 (not shown in FIG. 1) and one or more target values 164-1 (not shown in FIG. 1).

According to certain examples, the credit product engine 136-1 determines and/or updates the dynamic index 152-1 (and data values 156-1 of the electronic credit account 102-1 associated with each payment device 108) using input from a credit profile server 120, and/or a lending profile 148-1, and/or a market feed server 116.

Advantageously, the updating of the dynamic index 152-1 includes a closed feedback loop mechanism. The process starts with the core server 132-1 and/or the credit product engine 136-1 determining one or more current profile values 162-1 and one or more target values 164-1 for the electronic credit accounts 102-1 based in part on the lending profile 148-1, and activating data values 156-1 associated with the attribute values 154-1 in the dynamic index 152-1 corresponding with the one or more current profile values 162-1. Next, the credit product engine 136-1 monitors activity by payment devices 108 on the electronic credit accounts 102. Upon detecting changes to the current profile values 162-1 associated with the electronic credit accounts 102-1, the credit product engine 136-1 adjusts the dynamic index 152-1 (e.g., activating different data values 156-1) to urge utilization of the electronic credit accounts 102 (and more specifically the electronic accounts 102-1) by the payment devices 108 towards the target values 164-1. According to another example, where there are multiple credit product engines 136 operated by multiple financial institutions, financial information from a market feed server 116 (discussed below) or another central server can be used to determine the dynamic indexes 152, and the closed loop feedback mechanism can scale, in a fractal like way, where multiple credit product engines 136 monitor and update the dynamic indexes 152. Accordingly, dynamic adjusting of the dynamic index 152-1 provides an automated, close loop feedback mechanism to drive use of the electronic credit accounts 102 (and more specifically the electronic accounts 102-1) in accordance with targets determined by the lending profile 148-1 and/or business rules of the financial institution.

Typically, the core server 132 can communicate with a credit profile server 120 to send updates regarding one or more electronic credit accounts 102. Moreover, credit product engine 136 can communicate with the credit profile server 120 to receive one or more credit profile updates regarding credit attribute values 154 for one or more payment devices 108 and/or associated electronic credit accounts 102. The communications can be securely transmitted over the network 112. Accordingly, credit product engine 136-1 can communicate with the credit profile server 120 to receive credit profile updates related to credit attribute values 154-1 for the one or more payment devices 108 associated with electronic accounts 102-1.

Typically, the credit profile server 120 is a third party server operated by a credit reporting agency. In one example, the credit profile server 120 connects directly to the credit product engine 136-1 via network 112. According to this example, the credit profile server 120 is connected to a credit database 124 that maintains records about the usage of electronic credit accounts 102 associated with the payment devices 108 and/or the borrower. In one example, the credit profile server 120 can be operated by any party which is not a credit reporting agency.

The credit database 124 can be a database application loaded on the credit profile server 120, a stand-alone database server, a virtual machine, or any other suitable server. According to one example, the credit database 124 maintains credit data records 128-1, 128-2, . . . 128-o for each payment device 108-1, 108-2, . . . 108-o (and associated electronic credit accounts 102). For example, credit data record 128-1 can correspond with payment device 108-1, credit data record 128-2 can correspond with payment device 108-2, and so on. Typically, the credit profile server 120 communicates with each of the core server 132 or another system or subsystem of the financial institution intranet 104 and receives periodic updates or reports regarding the maintenance of the electronic credit accounts 102. The periodic reports can include updates regarding one or more attribute values 154-1, typically credit attribute values 154-1, for the electronic credit accounts 102 associated with payment devices 108. In response to receiving the periodic reports from one or more core servers 132-1, 132-2, etc., the credit profile server 120 can update the credit database 124, including the credit data records 128. The credit profile server 120 can send credit profile updates, including one or more updated credit data records 128, to the credit product engine 136-1. The credit product engine 136-1 can derive the current profile values 162-1 associated with the electronic accounts 102-1 or payment devices 108 from the credit profile updates.

Advantageously, the credit product engine 136-1 can update the dynamic index 152-1 (and data values 156-1) using monitored current profile values 162-1 from the credit profile server 120 included in the credit data records 128 that are associated with the payment devices 108. Advantageously, the dynamic index 152-1 can be determined and/or updated by the credit product engine 136-1 substantially in real-time, or at least with reduced latency.

The lending profile 148-1 indicates a financial institution's credit lending ability and risk tolerability. In one example, business rules for the financial institution determine the lending profile 148-1. The lending profile 148-1 can be stored in the memory of the credit product engine 136-1.

In one example, the market feed server 116 connects directly to the credit product engine 136-1 via network 112. Typically, the market feed server 116 provides lending information such as LIBOR (average interest rate), CDOR, and other financial data to the financial institution in order to draw its own capital loans (e.g. to determine the lending profile for the financial institution). Furthermore, in part based on the financial information, the credit product engine 136-1 determines or updates one or more dynamic indexes 152-1. For example, if the market feed server 116 indicates that LIBOR rates have increased, then the credit product engine 136-1 can automatically change the data values 156-1 for certain electronic credit accounts 102-1. Advantageously, the data values 156-1 can be determined and/or updated by the credit product engine 136-1 substantially in real-time, or at least with reduced latency, in response to information received from the market feed server 116.

Any of the credit product engine 136-1, the core server 132-1, the market feed server 116, and the credit profile server 120 can include a keyboard, mouse, touch-sensitive display (or other input devices), a monitor (or display, such as the touch-sensitive display, or other output devices).

According to one example, the attribute values, represented as attribute values 154-1 in the dynamic index 152-1, can be either credit attribute values 154-1 or transaction attribute values 154-1. And, according to various examples, the data value 156-1 can be associated with one or more credit attribute values 154-1, one or more transaction attribute values 154-1, or some combination of one or more credit attribute values 154-1 and one or more transaction attribute values 154-1.

According to one example, one or more credit attribute values 154-1 can be derived from the credit profile server 120. A credit attribute value 154-1 refers to a value derived from the credit data records 128. The credit data records 128 include information such as credit limit, balance, available credit limit, historical balance, original balance, utilization percentage, payment amount, etc., for one or more electronic credit accounts 102 associated with the borrower. Examples of credit attribute values 154-1 include total credit limit (from all electronic credit accounts 102 of the borrower), total balance (from all electronic credit accounts 102 of the borrower), total payment amount (from all electronic credit accounts 102 of the borrower), etc. Table 1 sets out a non-exhaustive list of credit attributes that can be used to establish credit attribute values 154-1. Table 1 can be stored in the credit profile server 120 (as an extension of credit data records 128) or in the credit product engine 136-1 (as a part of credit product data records 144-1).

TABLE 1
Credit attributes

Total balance across all credit accounts (“Total balance”)
Total balance across all revolving credit accounts
(“Total balance − revolving”)
Total balance across all installment credit accounts
(“Total balance − installment”)
Total credit-limit across all revolving accounts
(“Total credit-limit”)
Total original balance amount across all installment accounts
(“Total original balance”)
Utilization percentage across all revolving accounts
Number of credit inquiries in the past ‘x’ days, where ‘x’
can be any number of days such as 30, 60, and 90, etc.
Number of active credit accounts

According to certain examples, credit attribute values 154-1 can be grouped or sub-grouped by industry type (e.g., banks, credit unions, auto finance, personal finance, retail, etc.) or by the type of credit products (e.g., revolving credit card accounts, line of credit accounts, installment accounts, mortgages etc.).

In this specification, transaction attribute values 154-1 are values associated with usage of an electronic credit account 102 associated with the payment device 108. Example transaction attribute values 154-1 include transaction amount, transaction date, type of purchase made, merchant identifier, number of transactions, and the like. For example, business rules for a financial institution can define transaction attribute values 154-1 relating to transactions at special times of the year, or to a class of merchants, etc. The transaction attribute values 154-1 can be stored in the credit product data records 144-1 maintained by the credit product database 140-1.

The current profile value 162-1 represents the “current” value of the attributes associated with the attribute values 154-1 in the dynamic index 152-1. The ongoing changes to the current profile values 162-1 can be monitored by the credit product engine 136-1 based on credit profile updates received from the credit profile server 120 (e.g., related to credit attribute values 154-1) or based on data records received from the core servers 132 (e.g., related to transaction attribute values 154-1). The dynamic index 152-1 can be adjusted based on the changed current profile values 162-1. The current profile values 162-1 can be stored in the credit product data records 144-1 maintained by the credit product database 140-1.

Table 2 illustrates an example of a dynamic index 152-1-1 that associates data values 156-1-1 with attribute values 154-1-1 for payment device 108-1 (and the associated electronic credit account 102-1-1). Table 2 can be stored in the credit product data record 144-1-1 maintained by the credit product database 140-1 for access by the credit product engine 136-1.

TABLE 2
Example Dynamic Index

| Total balance | Interest rate |
|---|---|
| (attribute values 154-1-1) | (data values 156-1-1) |
| $0-5000 | Prime (P) % |
| $5000-10,000 | Prime + 5.00% |
| $10,000-30,000 | Prime + 10.00% |
| >$30,000 | Prime + 20.00% |

In the example shown in Table 2, the dynamic index 152-1-1 has four tiers or rows. The rows of Table 2 show the data values 156-1-1, representing product features of the electronic credit account 102-1-1 (e.g., interest rate), and the corresponding attribute values 154-1-1 (e.g., total balance) associated with the payment device 108-1 (and the associated electronic credit account 102-1-1). According to other examples, different attribute values 154-1-1 can be represented in the dynamic index 152-1-1 based on attributes such as “total balance-revolving” across multiple electronic credit accounts 102 associated with the payment device 108-1 and/or the borrower, or “total credit-limit” in a given time period, etc. As well, different data values 156-1-1 can be represented in the dynamic index 152-1-1.

For example, when the current profile value 162-1-1 is determined to be $2500, the data value 156-1-1 of Table 2 that is activated according to the methods disclosed herein is Prime %. This is obtained by matching the current profile value 162-1-1 with the attribute values 154-1-1 in the dynamic index 152-1-1 (i.e., by identifying the applicable tier in Table 2) to determine the applicable data values 156-1-1. Upon monitoring activity by the payment device 108-1, if the current profile value 162-1-1 (total balance) has increased to $7500, then the dynamic index 152-1-1 can be adjusted. For example, a different data value 156-1-1 can be activated (interest rate of Prime+5%) according to the dynamic index 152-1-1 of Table 2. This adjustment can better reflect a potential change to credit risk and urge a different utilization of the electronic credit account 102-1-1.

According to one example, the credit product data record 144-1 may include one or more target values 164-1 that are associated with the dynamic index 152-1. In one example, the target value 164-1 for Table 2 can be determined to be a “current” attribute value 154-1. Alternatively, the target value 164-1 can be determined according to a lending profile 148-1, a credit profile for the electronic credit account 102-1, or other business rules of the financial institution. For example, a target value 164-1 can be established to lower risk profile (e.g. to achieve a lower “total balance” associated with an electronic account 102-1 or the borrower) or to generate a desired risk adjusted return per the lending profile 148-1 for the electronic account 102-1 (e.g. to achieve a desired data value 156-1 for a given attribute value 154-1 as represented in the dynamic index 152-1). According to other examples, a target value 164-1 can be established to drive desired activity for the electronic credit account 102-1 such as balance transfer or payment transactions. In one example, target values 164-1 can correspond with attribute values 154-1 in a specific tier or row in the dynamic index 152-1. In another example, the target values 164-1 can correspond with a set of attribute values 154-1 with corresponding data values 156-1 in the dynamic index 152-1. In another example, the target values 164-1 can be embedded in the dynamic index 152-1 as attribute values 154-1 with corresponding data values 156-1. The target values 164-1 can be stored in the credit product data records 144-1 maintained by the credit product database 140-1.

Use of the terms “adjusting” and “adjustment” refers to any adjustment of the dynamic index 152-1-1 including an upward or downward change of row or position from a first row to a second row (i.e., activating the data value 156-1-1 corresponding to the attribute value 154-1-1 in the dynamic index 152-1-1 based on the changed current profile values 162-1-1). These examples are non-limiting; other adjustments include changing the composition or arrangement of the dynamic index 152-1-1 such as by changing, adding or removing rows, or more generically by changing associations between attribute values 154-1-1 and data values 156-1-1.

Table 3 illustrates a further example of a dynamic index 152-1-1 that associates data values 156-1-1 with attribute values 154-1-1. Table 3 can be stored in the credit product data record 144-1-1 maintained by the credit product database 140-1 for access by the credit product engine 136-1.

TABLE 3
Example Dynamic Index (Two-level)

| | Total credit-limit | |
|---|---|---|
| | (attribute values 154-1-1) | |
| | $0-$40,000 | >$40,000 |
| Total balance | Interest rate | Interest rate |
| (attribute values 154-1-1) | (data value 156-1-1) | (data value 156-1-1) |
| $0-$5,000 | 5.00% | 10.00% |
| $5,000-$10,000 | 10.00% | 15.00% |
| $10,000-$30,000 | 15.00% | 20.00% |
| >$30,000 | 20.00% | 25.00% |

In the example shown in Table 3, the dynamic index 152-1-1 has eight rows or tiers according to two levels. In this example, each row of Table 3 shows one of two data values 156-1-1 (e.g. interest rates), associated with two corresponding attribute values 154-1-1 (e.g. total balance and total credit-limit) associated with the payment device 108-1 and/or the electronic credit account 102-1-1. According to other examples, different, more, or fewer attribute values 154-1-1 can be represented in the dynamic index 152-1-1. As well, different, more, or fewer data values 156-1-1 can be represented in the dynamic index 152-1-1.

For example, where the current profile values 162-1-1 are determined to be $2500 (total balance) and $35,000 (total credit-limit), the data value 156-1-1 of Table 3 that is activated according to the methods disclosed herein is 5%. This is obtained by matching the current profile values 162-1-1 with the corresponding attribute values 154-1-1 in the dynamic index 152-1-1 [i.e. by identifying the applicable tier in Table 3] to determine the applicable data values 156-1-1. Upon monitoring activity by the payment device 108-1, if the total balance remains constant but the total credit-limit has increased to $45,000, then the dynamic index 152-1-1 can be adjusted and a different data value 156-1-1 can be activated (interest rate of 10%) according to the dynamic index 152-1-1 of Table 3, partially to reflect a potential change to credit risk and to urge utilization of the electronic credit account 102-1-1 toward the target values 164-1-1 of total balance in the range $0-5,000 and/or a total credit-limit in the range $0-40,000 (e.g. corresponding to the attribute values 154-1-1 at the start of this example).

While the examples illustrated above with reference to Table 2 and Table 3 have multiple tiers for attribute values 154-1-1 (four tiers for “Total balance” and/or two tiers for “Total credit-limit”), it will be appreciated that many other examples within the scope of the specification accommodate any number of tiers for one or more attribute values 154-1-1 and/or data values 156-1-1. Adjustments to the dynamic index 152-1-1 can be made immediately, or after a pre-determined delay. In one example, the length of the delay before the dynamic index 152-1-1 is adjusted can itself be considered a data value 156-1-1 that can be adjusted. In one example, the monitoring step can be performed on a periodic basis such as once a day or once a month.

According to other examples, the dynamic index 152 can be represented as an equation or any other technique that associates one or more data values 156 with one or more attribute values 154. For example, in an alternative embodiment, the dynamic index 152 can be based on an equation using one or more attribute values 154 where each attribute value 154 is given a particular weight which determines the associated data values 156. Alternatively, the dynamic index 152 can be a continuous function at least in part based on the attribute values 154 of the electronic credit 102 or the borrower that determines the associated data values 156. The present examples describe using a tiered dynamic index 152 for illustration purposes only, and are not intended to be limiting.

The above examples provides an illustration using simple examples, but it will be appreciated that each data value 156 can be associated with one or more attribute values 154. For example, each data value 156 can be associated with two, three, or more attribute values 154.

A block diagram of another example of a system 100A for processing data values 156-1 representing product features of an electronic credit account 102-1 is shown in FIG. 2. According to this example, architecture for a second financial institution is shown, including a core server 132-2 and a credit product engine 136-2. According to this example system 100A, credit product engines 136-1 and 136-2 can exchange records relating to transactions or other activity by payment devices 108. According to other examples, architecture for several financial institutions can be employed without departing from the present disclosure.

An example of the system 100A in operation will now be described. In this example, the credit product engine 136-1 enrolls three electronic accounts 102-1-1, 102-1-2, and 102-1-3, each respective to a payment device 108-1, 108-2, and 108-3. Each of the three payment devices 108 are also associated with different electronic credit accounts 102 associated with credit product engines 136-2 and 136-3 (e.g., electronic credit accounts 102-2-1, 102-2-2, and 102-2-3 administered by core server 132-2 and electronic credit accounts 102-3-1, 102-3-2, and 102-3-3 administered by core server 132-3 respectively). Architecture including core servers 132-1, 132-2, and 132-3, credit product engines 136-1, 136-2, and 136-3, etc. are maintained for each financial institution. The credit profile server 120 monitors or tracks activity of the payment devices 108 and the associated electronic credit accounts 102. The credit profile server 120 sends credit profile updates, including one or more credit data records 128, regularly to the three credit product engines 136. The credit profile updates can include current profile values 162-1 associated with each of the payment devices 108. In response to the monitoring, the credit product engine 136-1 can determine, and/or adjust a dynamic index 152-1 of attribute values 154-1 and associated data values 156-1 (representing product features of the three electronic credit accounts 102-1 managed by credit product engine 136-1). Advantageously, the dynamic index 152-1 and underlying credit risk of the borrowers can be based on activity by payment devices 108 (and/or associated electronic credit accounts 102 and/or the borrowers). The credit product engine 136-1 can cause data values 156-1 to be dynamically adjusted based, at least in part, on changes to the current profile values 162-1 and corresponding attribute values 154-1 in the dynamic index 152-1. Target values 164-1 can be determined according based on the lending profile 148-1 (e.g. constrained resources or risk tolerance levels, or other business rules for the financial institution). Use of the system 100A permits dynamic management of borrower risk profiles and risk adjusted returns.

In certain examples, the payment device 108 provides a notification including a periodic statement. The periodic statement typically includes details for the associated electronic credit account 102-1 such as previous outstanding balance, payments received, interest charges or other fees applied and new outstanding balance. Other details can be displayed, including a representation of the dynamic index 152-1 (for example, including one or more credit attribute values 154-1 and associated data values 156-1 representing product features) and any adjustments if applicable. Table 4 sets out an example for three payment devices 108-1, 108-2, and 108-3.

TABLE 4
Illustration of changes to data values 156-1

| | Month 1 | | Month 2 | | Month 3 | |
|---|---|---|---|---|---|---|
| | Current | | Current | | Current | |
| Pay- | profile | Data | profile | Data | profile | Data |
| ment | value | values | value | values | value | values |
| Device | 162-1 | 156-1 | 162-1 | 156-1 | 162-1 | 156-1 |
| 108-1 | $6000 | P + 5% | $4000 | P % | $40,000 | P + |
| | | | | | | 20% |
| 108-2 | $6000 | P + 5% | $7000 | P + 5% | $8000 | P + 5% |
| 108-3 | $6000 | P + 5% | $15,000 | P + | $2000 | P % |
| | | | | 10% | | |

In the example of Table 4, a credit product engine 136-1 enrolls three electronic credit accounts 102-1-1, 102-1-2, and 102-1-3, each respective to a payment device 108-1, 108-2, and 108-3. For the purpose of clarity and illustration, the dynamic index of Table 2 is applied for each of the three electronic credit accounts, in this example (as 152-1-1, 152-1-2 and 152-1-3 respectively). In the first period (Month 1), all the payment devices 108 have the same current profile value 162-1 (total balance) value of $6000; accordingly, the same data value (interest rate of P+5%) is activated based on data values 156-1-1, 156-1-2, and 156-1-3 respectively, for each of the three electronic credit accounts. This is obtained by matching the current profile values (162-1-1, 162-1-2, 162-1-3) with the corresponding attribute values (154-1-1, 154-1-2 and 154-1-3) in the dynamic indexes (152-1-1, 152-1-2 and 152-13) [i.e. by identifying the applicable tier in Table 2] to determine the applicable data values (156-1-1, 156-1-2 and 156-1-3) respectively. In the second period (Month 2), the current profile value 162-1-1 (total balance) for payment device 108-1 has been reduced to $4000 and the dynamic index 152-1-1 is adjusted to activate a different data value 156-1-1 (interest rate of P %) for the electronic account 102-1-1 associated with payment device 108-1. In the second period (Month 2), the current profile value 162-1-2 (total balance) for payment device 108-2 has increased to $7000 and the data value 156-1-2 (interest rate) is kept at P+5% as no adjustment of the dynamic index 152-1-2 is made. In the second period (Month 2), the current profile value 162-1-3 (total balance) for payment device 108-3 has increased to $15,000 and the dynamic index 152-1-3 is adjusted to activate a different data value 156-1-3 (interest rate) of P+10%. In the third period (Month 3), the current profile value 162-1-1 (total balance) for payment device 108-1 has increased to $40,000 and the dynamic index 152-1-1 is adjusted to activate a different data value 156-1-1 (interest rate) of P+20%. In the third period (Month 3), the current profile value 162-1-2 (total balance) for payment device 108-2 has increased to $8000 and the data value 156-1-2 (interest rate) is kept at P+5% as no adjustment of dynamic index 152-1-2 is made. In the third period (Month 3), the current profile value 162-1-3 (total balance) for payment device 108-3 has been reduced to $2000 and the dynamic index 152-1-3 is adjusted to activate a different data value 156-1-3 (interest rate) of P %. In other examples, the activity of additional payment devices 108 can be monitored, different, fewer, or more attribute values 154-1 can be monitored, and the adjusting can include activating one or more data values 156-1 representing product features in response to changes to one or more of current profile values 162-1, lending profile 148-1, etc.

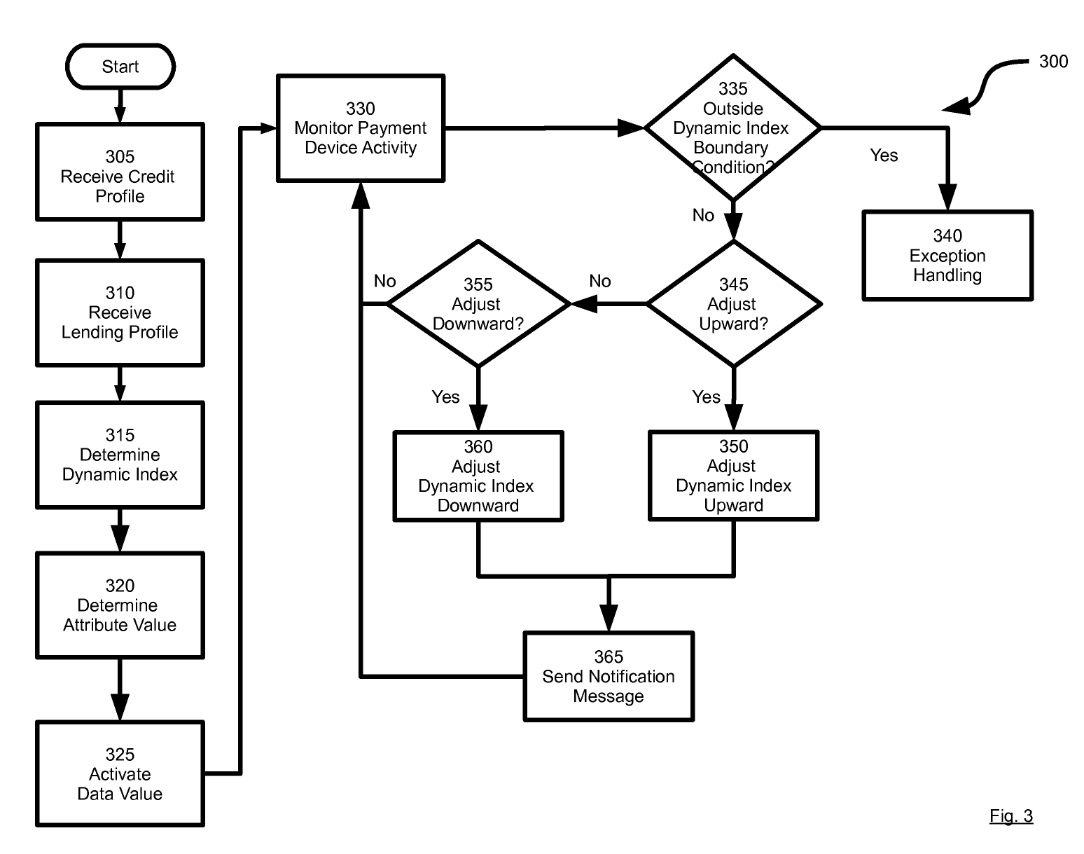

A flowchart illustrating an example of a disclosed method of processing data values 156-1 representing product features of an electronic credit account 102-1 is shown in FIG. 3. This method can be carried out by software executed by, for example, the processor of the credit product engine 136-1. The methods can contain additional or fewer processes than shown and/or described, and can be performed in a different order. Computer-readable code executable by at least one processor of the credit product engine 136-1 to perform the methods can be stored in a computer-readable storage medium, such as a non-transitory computer-readable medium.

With reference to FIG. 3, the method 300 starts and at 305, the credit product engine 136-1 receives a credit profile from the credit profile server 120. At 310, the credit product engine 136-1 receives the lending profile 148-1. At 315, the credit product engine 136-1 determines a dynamic index 152-1 including data values 156-1 representing product features based on the received credit profile and the lending profile 148-1.

At 320 of FIG. 3, the credit product engine 136-1 determines the applicable attribute value 154-1-1 for the electronic credit account 102-1-1 associated with the payment device 108-1 using, for example, the credit profile. At 325, the credit product engine 136-1 activates a current data value 156-1-1 based on the associated attribute value 154-1-1. The attribute value 154-1-1 can be one or more credit attribute values 154-1-1, one or more transaction attribute values 154-1-1, or some combination thereof. Activation refers to activating or enabling the data value or values 156-1-1 representing product feature(s) that are associated with the determined attribute values 154-1-1.

Still with reference to FIG. 3, at 330, the credit product engine 136-1 monitors activity by the payment device 108-1. Where transactions are made by the payment device 108-1 using the electronic credit account 102-1-1 associated with the financial institution intranet 104-1 (i.e., the same financial institution), the core server 132-1 can send data records representing the transaction attribute values 154-1-1 to the credit product engine 136-1. Where transactions are made with different financial institutions, the core server 132-2 (i.e., the core server 132 of the second financial institution) can send data records representing the transaction attribute values 154-1-1 to the credit product engine 136-1 (i.e., the credit product engine 136 of the first financial institution). Alternatively, the credit profile server 120 can send updates or information regarding activity on the payment device 108-1 associated with the electronic credit account 102-1-1 (i.e., to derive the updated current profile values 162-1-1 for the payment device 108-1 or associated electronic credit account 102-1-1) to the credit product engines 136.

The term “monitor payment device activity” is intended to encompass many types of activity associated with the payment device 108-1 and/or the electronic credit account 102-1-1. Any data source supplying activity regarding the electronic credit accounts 102 can be consulted for step 330, which is not limited to these disclosed examples.

At 335 of FIG. 3, the credit product engine 136-1 has detected a transaction (or other activity by the payment device 108-1) and determines if a boundary condition for the dynamic index 152-1-1 has been exceeded. If so, exception handling procedures are invoked at 340. An exception is the occurrence of an anomalous event, e.g. during communication of or processing of records (i.e., updates to one or more current profile values 162-1-1) from the credit profile server 120. Exception handling procedures include notification and reporting on the display of the credit product engine 136-1, or the display of the core server 132-1, for example. Otherwise, the credit product engine 136-1 determines if an adjustment to the dynamic index 152-1-1 is to be made, either upward at 345, or downward at 355. For example, should a transaction (or other activity by the payment device 108-1) cause a current profile value 162-1-1 to exceed a tier or row of the dynamic index 152-1-1 (i.e., exceed the current tier value of associated attribute value 154-1-1), then an adjustment to the dynamic index 152-1-1 (i.e., activating a data value 156-1-1 at the next row or tier) can be made. The dynamic index 152-1-1 is adjusted upward at 350, or downward at 360, respectively. A notification of the adjustment is provided to the payment device 108-1 at 365. After the notification is provided, or if no adjustment is to be made, then the process continues with further monitoring of activity by the payment device 108-1 at 330. While the example above refers to an adjustment of the dynamic index 152-1-1 from one tier to the next tier, it will be appreciated that the scope of the present disclosure encompasses any adjustment of the dynamic index 152-1-1.

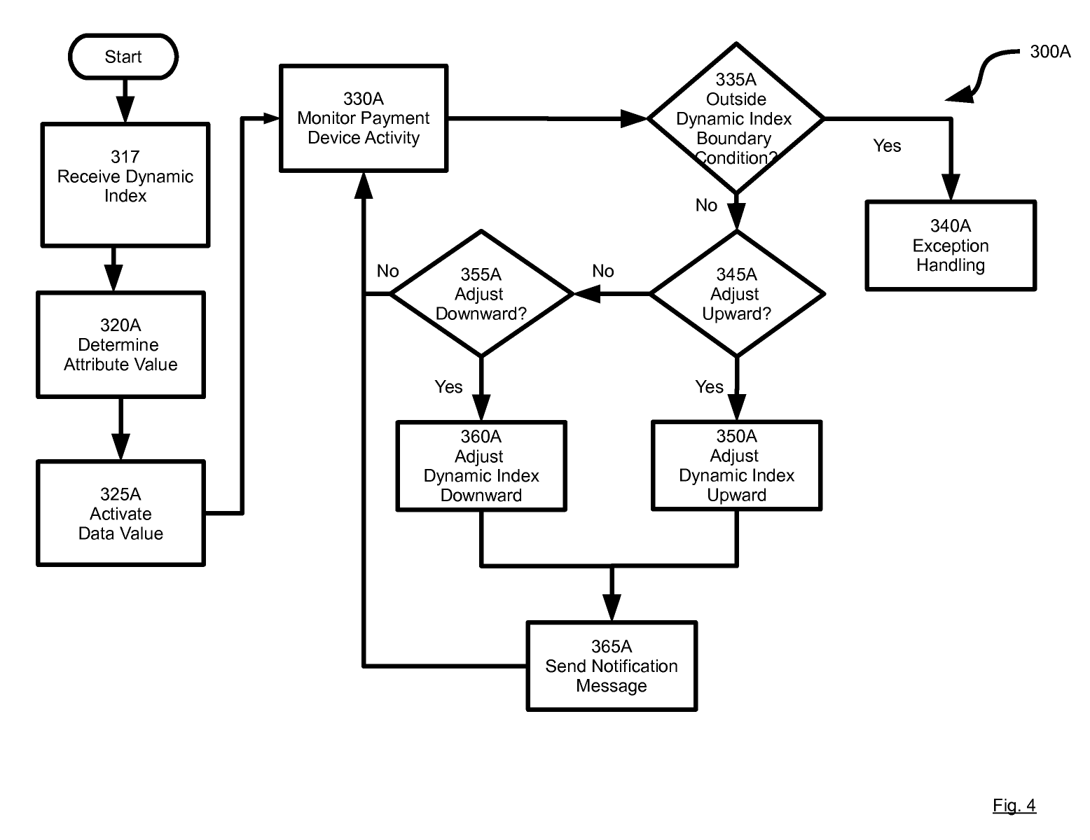

A flowchart illustrating another example of a disclosed method of processing data values 156-1-1 representing product features of an electronic credit account 102-1-1 is shown in FIG. 4. In this example, a method 300A does not include some of the receiving and determining steps of method 300. At 317, the credit product engine 136-1 receives a pre-determined dynamic index 152-1-1. The method then continues at 320A, according to the corresponding step 320 of method of FIG. 3. According to this example, the dynamic index 152-1-1 can be instantiated by a separate procedure and need not be generated or created by the credit product engine 136-1 according to the disclosed methods.

According to one example, one of the attribute values 154-1-1 for the payment device 108-1 can be designated as a target value 164-1-1. The target value 164-1-1 can be derived from the financial institution's lending profile 148-1 (e.g. a target level of a constrained resource such as an underlying capitalization value).

Advantageously, the data values 156-1-1 associated with the payment device 108-1 can be determined and/or updated by the credit product engine 136-1 substantially in real-time, or at least with reduced latency. Conventionally, product features were updated at the time of enrollment or by some manual procedure, dated sporadically, with no or limited transparency, and not updated on a substantially real-time basis. In contrast, examples in the present specification provide methods and systems to enable at least partially automated techniques to determine and/or update or adjust the data values 156-1-1 of the electronic credit account 102-1-1 with a reduced time lag or latency. Additionally, examples are provided for monitoring of current profile values 162-1-1 associated with the electronic credit account 102-1-1, and providing a closed feedback loop for adjusting the associated data values 156-1-1 based on the corresponding attribute values 154-1-1 in the dynamic index 152-1-1. Moreover, the system 100 (and with appropriate modifications, the system 100A) can be used to enable distributed monitoring of multiple payment devices 108 (and associated electronic credit accounts 102) to determine a target capitalization (stored in a lending profile 148-1 and accessible by the financial institution intranet 104-1), and to reduce the latency of adjusting data values 156-1 as a response to the monitoring to achieve the target capitalization. Moreover, the system 100 can be used to at least partially reduce latency and improve reporting or notification to payment devices 108 of changes to the data values 156-1 associated with the electronic credit accounts 102-1.

Advantageously, the system 100 includes continuous monitoring of activity by payment devices 108 (and associated electronic credit accounts 102) via a closed communication loop to dynamically adjust one or more dynamic indexes 152. In response to the monitoring of activity by one or more payment devices, the system 100 is configured to correspondingly dynamically modify the dynamic index 152 (e.g., data values 156) in order to urge future utilization of the electronic credit accounts 102 towards target values 164.

The continuous adjustment of one or more dynamic indexes 152 (e.g., data values 156) can reduce the latency or time lag between a change in usage of electronic credit accounts 102 and responses by credit product engines 136 to change data values 156. Electronic credit accounts 102 can better reflect changing credit risk providing at least partially increased transparency to the borrowers, more effective credit risk management strategies with reduced latency, and improved usage of electronic credit accounts 102 in accordance with established target values 164.

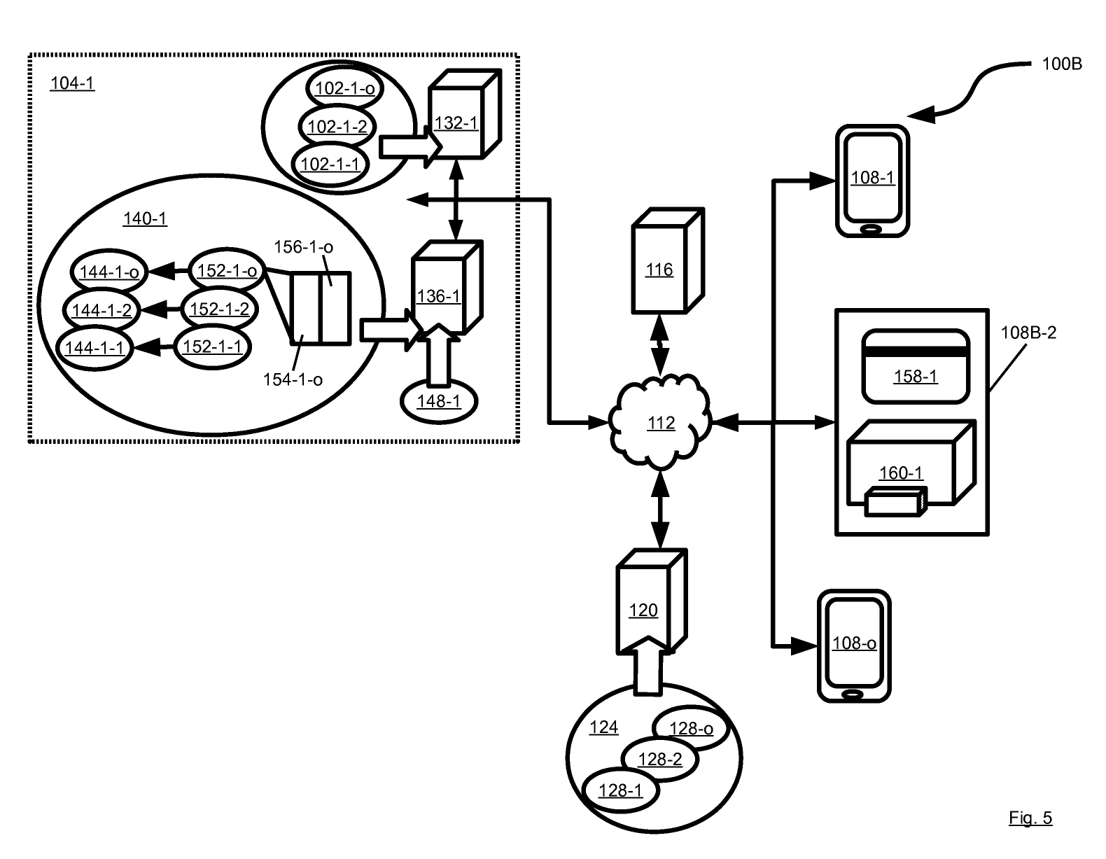

A block diagram of another example of a system 100B for processing data values 156-1 of electronic credit accounts 102-1 is shown in FIG. 5. According to this example, payment device 108B may comprise a credit card 158-1 (or bank card, etc.) and a printer 160-1. The credit card 158-1 provides payment and point of sale capabilities to enable payments and transactions such as purchases to be made on the electronic credit account 102-1 associated with the payment device 108B. The printer 160-1 provides reporting capabilities associated with the electronic credit account 102-1.

A system includes a core server for administration of one or more electronic credit accounts, a plurality of payment devices for payment and receipt of notifications in relation to the one or more electronic credit accounts, a credit product engine including at least one processor, a memory coupled to the credit product engine for storing data, an application program stored in the memory and accessible by the at least one processor for directing processing of the data by the at least one processor, and a credit product database for maintaining a plurality of credit product data records. Each credit product data record includes a dynamic index of attribute values and associated data values representing product features for the one or more electronic credit accounts. The credit product engine is in communication with the core server over a network, and the at least one processor is configured to determine one or more current profile values and one or more target values for each electronic credit account, in response to the determining step, activate one or more current data values representing one or more current product features associated with the one or more attribute values in the dynamic index corresponding with the one or more current profile values, monitor activity on the electronic credit accounts by the payment devices wherein the monitoring includes receiving one or more credit data records over the network, and, in response to the monitoring, dynamically adjust the dynamic index to urge utilization of the electronic credit accounts by the payment devices towards the target values.

The at least one processor can be configured to continuously dynamically adjust the dynamic index providing a closed feedback loop in response to the monitoring.

The system can include a credit profile server connected to the credit product engine over the network for transmission of credit data records to the credit product engine, wherein the at least one processor is configured to dynamically adjust the dynamic index based on the credit data records received from the credit profile server.

The system can include a market feed server connected to the credit product engine over the network for transmission of financial information updates, and more specifically, average interest rate updates, and wherein the dynamic index is adjusted based on the financial information updates.

A method includes, in a credit product engine including at least one processor and a credit product database maintaining a plurality of credit product data records and where the credit product engine is connected to a network: receiving a dynamic index of one or more attribute values and one or more associated data values representing product features for an electronic credit account, maintaining the dynamic index in one of the plurality of credit product data records, determining one or more current profile values and one or more target values for the electronic credit account, in response to the determining step, activating one or more current data values representing one or more current product features associated with the one or more attribute values in the dynamic index corresponding with the one or more current profile values, monitoring activity on the electronic credit account by at least one payment device wherein the monitoring includes receiving one or more credit data records over the network, and in response to the monitoring step, dynamically adjusting the dynamic index to urge utilization of the electronic credit account by the at least one payment device towards the target values.

An alternative method includes, in a credit product engine including at least one processor and a credit product database maintaining a plurality of credit product data records where the credit product engine is connected to a network: receiving a current profile value indicating a debt servicing ability for an electronic credit account, receiving a lending profile value indicating a credit lending ability for the electronic credit account, in response to the receiving steps, determining a dynamic index of attribute values and associated data values representing product features for an electronic credit account, one or more current profile values, and one or more target values for the electronic credit account, maintaining the dynamic index in one of the plurality of credit product data records, in response to the determining step, activating one or more current data values representing one or more current product features associated with the one or more attribute values in the dynamic index corresponding with the one or more current profile values, monitoring activity on the electronic credit account by at least one payment device wherein the monitoring includes receiving one or more credit data records over the network, and, in response to the monitoring step, dynamically adjusting the dynamic index to urge utilization of the electronic credit account by the at least one payment device towards the target values.

The method can further include monitoring the received credit data records for changes to the one or more current profile values. The adjusting can further include, in response to the monitoring step, activating one or more data values representing one or more product features associated with the one or more changed current profile values.

The dynamic index can include one or more rows of attribute values and associated data values. The adjusting can further include determining if the dynamic index is to be adjusted upward or downward from a current row. In response to the determining step, the adjusting can further include activating a data value representing a product feature associated with a row upward (or downward) from the current row, where the dynamic index is to be adjusted upward (or downward).

The activating steps can be performed in real-time or after a pre-determined time lag.

The attribute values can be selected from one or more of: credit attribute values, and more specifically, total credit attribute values, transaction attribute values, and a combination of credit attribute values and transaction attribute values. The credit attribute values can be derived from one or more of credit limit, balance, available credit limit, historical balance, original balance, utilization percentage and payment amount for the electronic credit account and associated electronic credit accounts. The transaction attribute values can be derived from one or more of: an amount of a transaction, a date of the transaction, a type of transaction, a merchant identifier for the transaction, and a quantity of transactions.

The data values can be selected from one or more of: interest rate, credit limit, payment period, annual fee, late fee, points, rewards, locked status and unlocked status for the electronic credit account.

The payment device can include one or more of a credit card, a secured credit card, a pre-paid credit card, a retail store card, an installment loan, a personal loan, a personal line of credit, an auto loan, a mortgage, a home equity line of credit and a home equity loan. The payment device can further include a printer for enabling receipt of the notifications in relation to the one or more electronic credit accounts or a display for enabling receipt of the notifications in relation to the one or more electronic credit accounts.

The dynamic index can be determined according to one or more levels of one or more rows associating the one or more attribute values and the one or more data values. Alternatively, the dynamic index can be determined according to one of: an equation and a function relating the attribute values and the associated data values. The function can be one of: a continuous function and a step function relating the attribute values and the associated data values.

The target values can be associated with the one or more of: one or more attribute values, one or more data values and a combination of one or more attribute values and one or more data values.

While a number of exemplary aspects and examples have been discussed above, those of skill in the art will recognize certain modifications, permutations, additions and sub-combinations thereof.

What is claimed is:

1. A system comprising:
a core server for administration of one or more electronic credit accounts;
a plurality of payment devices for payment and receipt of notifications in relation to the one or more electronic credit accounts;
a credit product engine comprising at least one processor, a memory coupled to the credit product engine for storing data, an application program stored in the memory and accessible by the at least one processor for directing processing of the data by the at least one processor, and a credit product database for maintaining a plurality of credit product data records, wherein each credit product data record includes a dynamic index comprising attribute values and associated data values representing product features for the one or more electronic credit accounts, the credit product engine is in communication with the core server over a network, and the at least one processor is configured to:
determine one or more current profile values and one or more target values for each electronic credit account;
in response to the determining step, activate one or more current data values representing one or more current product features associated with the one or more attribute values in the dynamic index corresponding with the one or more current profile values;
monitor activity on the electronic credit accounts by the payment devices wherein the monitoring comprises receiving one or more credit data records over the network; and
in response to the monitoring, dynamically adjust the dynamic index to urge utilization of the electronic credit accounts by the payment devices towards the target values.

2. The system according to claim 1 wherein the at least one processor is configured to continuously dynamically adjust the dynamic index providing a closed feedback loop in response to the monitoring.

3. The system according to claim 1 further comprising a credit profile server connected to the credit product engine over the network for transmission of credit data records to the credit product engine, wherein the at least one processor is configured to dynamically adjust the dynamic index based on the credit data records received from the credit profile server.

4. The system according to claim 1 further comprising a market feed server connected to the credit product engine over the network for transmission of financial information updates, and more specifically, average interest rate updates, and wherein the dynamic index is adjusted based on the financial information updates.

5. A method comprising, in a credit product engine comprising at least one processor and a credit product database maintaining a plurality of credit product data records and where the credit product engine is connected to a network:
receiving a dynamic index comprising one or more attribute values and one or more associated data values representing product features for an electronic credit account;
maintaining the dynamic index in one of the plurality of credit product data records;
determining one or more current profile values and one or more target values for the electronic credit account;
in response to the determining step, activating one or more current data values representing one or more current product features associated with the one or more attribute values in the dynamic index corresponding with the one or more current profile values;
monitoring activity on the electronic credit account by at least one payment device wherein the monitoring comprises receiving one or more credit data records over the network; and
in response to the monitoring step, dynamically adjusting the dynamic index to urge utilization of the electronic credit account by the at least one payment device towards the target values.

6. A method comprising, in a credit product engine comprising at least one processor and a credit product database maintaining a plurality of credit product data records where the credit product engine is connected to a network:
receiving a current profile value indicating a debt servicing ability for an electronic credit account;
receiving a lending profile value indicating a credit lending ability for the electronic credit account;
in response to the receiving steps, determining a dynamic index comprising attribute values and associated data values representing product features for an electronic credit account, one or more current profile values, and one or more target values for the electronic credit account;
maintaining the dynamic index in one of the plurality of credit product data records;
in response to the determining step, activating one or more current data values representing one or more current product features associated with the one or more attribute values in the dynamic index corresponding with the one or more current profile values;
monitoring activity on the electronic credit account by at least one payment device wherein the monitoring comprises receiving one or more credit data records over the network; and
in response to the monitoring step, dynamically adjusting the dynamic index to urge utilization of the electronic credit account by the at least one payment device towards the target values.

7. The method according to claim 5 wherein the monitoring further comprises:
monitoring the received credit data records for changes to the one or more current profile values;
wherein the adjusting further comprises:
in response to the monitoring step, activating one or more data values representing one or more product features associated with the one or more attribute values in the dynamic index corresponding with the one or more changed current profile values.

8. The method according to claim 7 wherein the dynamic index comprises one or more rows of attribute values and associated data values and the adjusting further comprises:
determining if the dynamic index is to be adjusted upward or downward from a current row;
in response to the determining step, activating a data value representing a product feature associated with a row upward from the current row, where the dynamic index is to be adjusted upward; and
in response to the determining step, activating a data value representing a product feature associated with a row downward from the current row, where the dynamic index is to be adjusted downward.

9. The method according to claim 7 wherein the activating steps are performed in real-time or after a pre-determined time lag.

10. The method according to claim 5 wherein the attribute values are selected from one or more of:
credit attribute values, and more specifically, total credit attribute values;
transaction attribute values; and
a combination of credit attribute values and transaction attribute values.

11. The method according to claim 10 wherein the credit attribute values are derived from one or more of credit limit, balance, available credit limit, historical balance, original balance, utilization percentage and payment amount for the electronic credit account and associated electronic credit accounts.

12. The method according to claim 10 wherein the transaction attribute values are derived from one or more of: an amount of a transaction, a date of the transaction, a type of transaction, a merchant identifier for the transaction, and a quantity of transactions.

13. The method according to claim 5 wherein the data values are selected from one or more of: interest rate, credit limit, payment period, annual fee, late fee, points, rewards, locked status and unlocked status for the electronic credit account.

14. The method according to claim 5 wherein the payment device comprises one or more of: a credit card, a secured credit card, a pre-paid credit card, a retail store card, an installment loan, a personal loan, a personal line of credit, an auto loan, a mortgage, a home equity line of credit and a home equity loan.

15. The method according to claim 14 wherein the payment device comprises one of: a printer and a display for enabling receipt of the notifications in relation to the one or more electronic credit accounts.

16. The method according to claim 5 wherein the dynamic index is determined according to one or more levels of one or more rows associating the one or more attribute values and the one or more data values.

17. The method according to claim 5 wherein the dynamic index is determined according to one of: an equation and a function relating the attribute values and the associated data values.

18. The method according to claim 17 wherein the function is one of: a continuous function and a step function relating the attribute values and the associated data values.

19. The method according to claim 5 wherein the one or more target values are associated with the one or more of:
one or more attribute values;
one or more data values; and
a combination of one or more attribute values and one or more data values.
